(19) United States
(12) Patent Application Publication
(10) Pub. No.: US 2015/0233150 A1
(43) Pub. Date: Aug. 20, 2015

(54) MOTOR VEHICLE DOOR

(71) Applicant: Kiekert Aktiengesellschaft, Heiligenhaus (DE)

(72) Inventor: Stephan Mittelbach, Velbert (DE)

(21) Appl. No.: 14/425,160

(22) PCT Filed: Aug. 17, 2013
(86) PCT No.: PCT/DE2013/000478

§ 371 Date: Mar. 2, 2015

(30) Foreign Application Priority Data
Aug. 28, 2012 (DE) 10 2012 008 326.0

(51) Int. Cl. E05B 81/06; B60J 5/00

(52) U.S. Cl. CPC E05B 81/06; B60J 5/00

(57) ABSTRACT

The invention relates to a motor vehicle door comprising a motor vehicle door lock (2), also a manipulation element (5) which is accessible from the outer side of the door and which can be impinged upon, in addition to a security unit (8, 10, 11) in the motor vehicle door lock (2) and driven by a motor (10) by means of one or more output elements (11). Said security unit, (8, 10, 11) can be controlled by a motor or manually by means of the manipulation element (5) so that it is placed in a “locked” “unlocked ” position. Said manipulation element (5) is connected to at least one output element (11) of the motor (10).

### CROSS-REFERENCE TO RELATED APPLICATIONS

This application is the U.S. national stage application of International Patent Application No. PCT/DE2013/000478, filed Aug. 17, 2013, which claims priority of German Application No. 10 2012 008 326.0, filed Aug. 28, 2012, which are both hereby incorporated by reference.

### BACKGROUND

The invention relates to a motor vehicle door comprising a motor vehicle door lock, also a manipulation element which is accessible from the outer side of the door and which can be impinged upon as well as a security unit in the motor vehicle door lock and driven by a motor by means of one or more output elements and in which said security unit can be controlled by a motor or manually by means of the manipulation element so that it is placed in a “locked” or “unlocked” position.

In a motor vehicle door of the above design as disclosed in DE 10 2009 001 851 A1, the security unit is a locking unit. The manipulation element is an actuation element of an emergency locking means, designed as an emergency lock switching nut. The emergency lock switching nut is arranged on the motor vehicle door and concealed from outside in such a way that from its position is not apparent from the outside whether the respective motor vehicle door can be readily opened from the outside or not.

During a failure of a central locking unit or of a motor-adjusted security unit, the emergency lock switching nut can be moved into a blocking position. This corresponds to the position “secured” or the position “locked” of the central locking unit disclosed in DE 10 2009 001 851 A1. As a result, the described emergency locking function is possible and is provided and, in particular for the case that the usual locking system is not functional and consequently that the respective vehicle can not be locked in a theft-proof manner. Such emergency situations in central locking systems can, for instance, occur in case of a flat motor vehicle battery or the battery no longer producing sufficient power to provide the typically electrically generated locking and unlocking with the aid of the electric motor.

For this purpose, the known manipulation element is designed as an emergency lock switching nut and the bearing is connected to an associated external locking switching nut. In this way, the external locking switching nut and thus the locking unit or the security unit can be manually moved into the “secured” or “locked” position with the aid of the manipulation element.

In a lock containing a central locking unit as disclosed in DE 41 08 561 C2 a rotating body is provided on the motor vehicle door. In case of a failure of the central locking unit, the rotating body allows mechanical movement of the securing lever into the securing position. In this way the closed door is locked from the outside.

A similar emergency locking means is disclosed in utility patent DE 203 12 347 U1 of the applicant. In this case a cover is providing a temporarily lockable housing opening allowing insertion of an external manipulation element. With the aid of said manipulation element the locking lever mounted in the housing can be moved into a locking position. This aims to ensure a reliable operation throughout the entire service life of the motor vehicle.

### SUMMARY

The prior art is not satisfactory in all aspects. The manipulation element, for instance, regularly operates the security unit via one or several levers or acts on one or several levers of the securing unit inside the motor vehicle door lock. This typically means that the movements of the manipulation element have to be deflected. This not only results in frictional losses but also in a relatively complex design. Furthermore, additional elements are required that impair or can impair the reliable operation over long periods of time and do, in any case, cause considerable costs. The invention aims to remedy this.

The invention is based on the technical problem of further developing a motor vehicle door of the aforementioned design in such a way that a more reliable manual control of the security unit is achieved with a simpler design and thus at reduced costs.

In order to solve this technical problem a generic motor vehicle door of the invention is characterized in that the manipulation element is connected to at least one output element of the motor.

Generally the manipulation element and the output element form a single piece. Overall it has been advantageous for the manipulation element and the output element to define a unit made, for instance, of plastic. Such a unit made of plastic can be particularly simple and cost-effective so that the costs associated with the manipulation element are practically immaterial compared to a motor vehicle door without such a manipulation element.

Apart from the described cost savings such an embodiment is also more reliable as the manipulation element and the output element preferably forms a single unit so that manual acting on the manipulation element directly acts on the output element in the desired manner. The manipulation element can thus directly engage in the drive train of the motor of the security unit, replacing so to speak the function of the motor.

The invention is based on the knowledge that the motor is typically an electric motor with little self-locking. The manipulation element can consequently be easily used for taking over or representing the function of the motor by the output element being acted upon accordingly with the aid of the manipulation element in order to provide the required position of the security unit.

Generally, the security unit is a locking unit. The manipulation element connected to the output element is consequently used in most cases for moving the locking unit into the “locked” position. This applies, in particular, in case that the locking unit or its motor has failed. The locking unit is typically a central locking unit.

For this purpose the manipulation element is designed as a switching nut with an actuation slot. This means that the manipulation element or the switching nut can at least be moved into the functional positions “locked” or “unlocked” provided the security unit is the preferred locking unit. Generally, the security unit can also be designed as an anti-theft device. In this case the output element of the motor and thus the overall security unit can be acted upon by the manipulation element in such a way that it takes up, for instance, the “locked” function. The associated motor vehicle door can consequently generally not be opened.

The manipulation element is typically arranged in an opening of a door lock housing. The door lock housing is generally made of plastic. As the manipulation element and the drive element preferably form a single plastic unit and define an integral unit of this plastic, this area produces a low friction due to the “plastic/plastic” contact. This further increases reliability and operational reliability.

In this context it has proven to be further advantageous for the manipulation element to be cylindrical and the said opening in the door lock housing being designed as a corresponding cylindrical opening. It therefore suffices to simply insert the manipulation element in the opening so that it engages. Also the manipulation element generally rises up from the driven pulley or generally the output element. The manipulation element is also in most cases arranged centrally in relation to the driven pulley so that the manipulation element directly acts and can also act on the centre of the driven pulley.

As already explained, the output element is advantageously a driven pulley. The driven pulley generally meshes with a worm gear connected to a drive shaft of the motor. As the motor is regularly an electric motor and thus has relatively low self-locking forces, the driven pulley can be easily moved into the “locked” (and also “unlocked”) position with the aid of the manipulation element. During this process, the motor or electric motor is carried along.

The position “locked” of the security unit and, according to an advantageous embodiment of the locking unit preferably corresponds to the “locked position”. This “locked” position of the motor vehicle door can be particularly easily and accurately implemented if the driven pulley acts on an external locking element and/or internal locking element. Generally, the driven pulley pivots the external locking element or the external locking lever into a position in which the actuation of an associated external door handle has no effect. This is the usual function in the “locked” position of the locking unit.

As a result, a motor vehicle door is provided that contains a simply designed and particularly reliable manipulation element. The manipulation element is accessible from the outside and can be acted upon manually, by for instance a screw driver or a key bit or a similar manipulation element being inserted in a groove or the actuation slot of the switching nut. Generally, the manipulation element can also contain a ribbed handle button or similar. In any case, the position of the manipulation element accessible from the outside does not give any indication of the security unit inside the motor vehicle door lock, as is generally the case for such emergency locking means.

### BRIEF DESCRIPTION OF THE DRAWINGS

Below, the invention is explained in more detail with reference to drawings showing only one embodiment, in which:

FIGS. 1 and 2 show a front view of the motor vehicle door with the attached motor vehicle door lock in different installation situations and

FIG. 3 shows a rear view of the motor vehicle door lock of FIGS. 1 and 2.

### DETAILED DESCRIPTION OF THE DRAWINGS

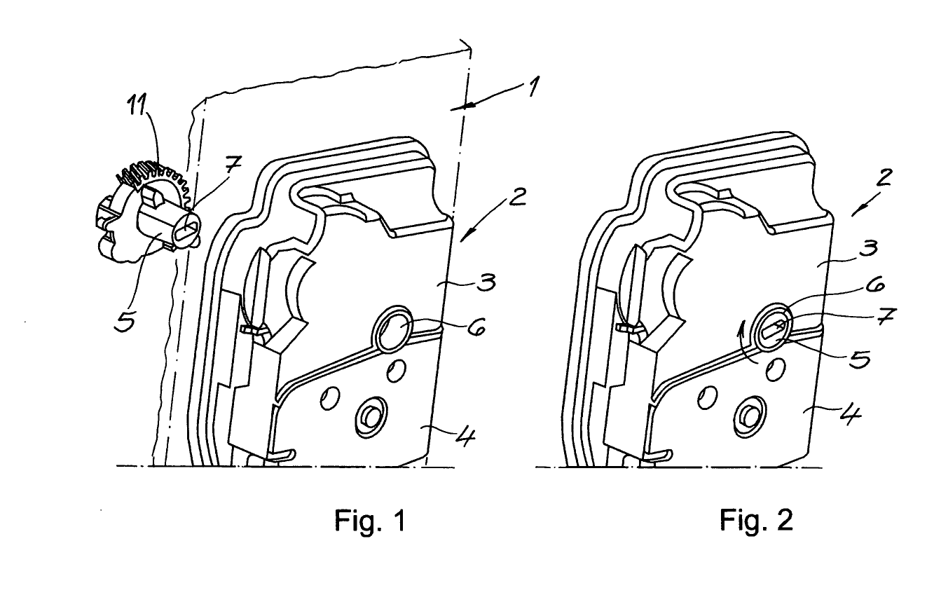

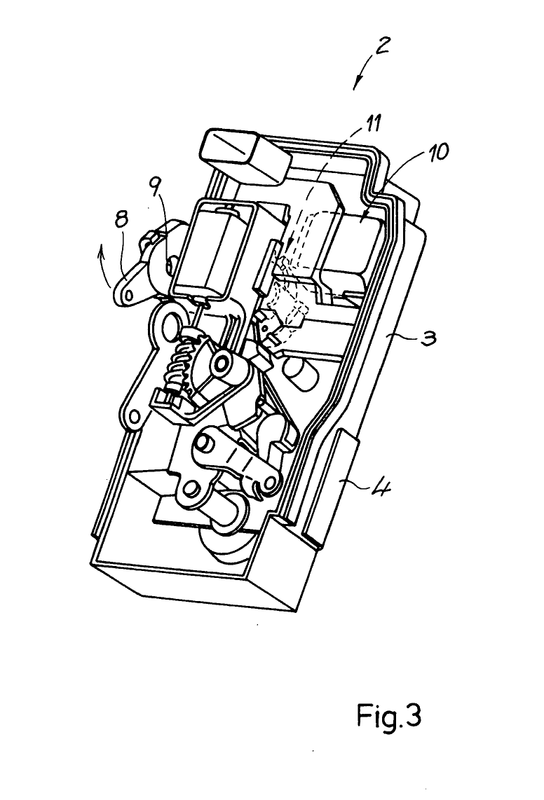

The figures show a motor vehicle door which is only indicated in FIG. 1 and manifests itself based on one front side 1 of the respective motor vehicle door. A motor vehicle door lock 2 is arranged inside the motor vehicle door, of which FIGS. 1 and 2 primarily show a motor vehicle door housing 3 and a lock case 4 with the usual functionality. FIG. 3 shows the opened plastic motor vehicle door lock housing 3 with the covering removed. In contrast to the motor vehicle door lock housing 3 the lock housing 4 is made of metal.

The main structure furthermore contains a manipulation element 5 that is accessible and can be acted upon from the external door side. From the figures and, in particular, from FIGS. 1 and 2 it is apparent that the manipulation element 5 has a predominantly cylindrical shape and engages in a corresponding cylindrical opening 6 in the motor vehicle door lock housing 3 made of plastic.

The manipulation element 5 is predominantly a switching nut 5, containing a slot or an actuating slot 7 allowing engagement of a manipulation element which is not shown. This manipulation element can be screw driver or a key bit of a motor vehicle door lock etc. This manipulation tool can be used to pivot the manipulation element or the switching nut 5 from the “unlocked” position shown in FIG. 2 into a “locked” position, corresponding in the example embodiment to a clockwise rotation taking into consideration an approximate quarter circle, as indicated by the arrow.

The thus assumed “locked” position of the manipulation element 5 causes a locking lever 8—only indicated in FIG. 3—to be pivoted around its axis 9 in the direction of the arrow shown in FIG. 3. As a result, the associated locking lever chain is interrupted. The locking lever 8 can, as shown in the example, be an external locking lever, so that in this case, the external locking lever chain is interrupted and an external door handle—not shown—remains idle, as already explained in detail above with reference to prior art disclosed, for instance, in DE 10 2009 001 851 A1 or also in DE 41 08 561 C2 or DE 203 12 347 U1.

In this case a security unit 8, 10, 11 driven by a motor 10 via an output element 11, acts as a locking unit 8, 10, 11. Naturally this only serves as an example and does not restrict the scope of the invention. The locking lever 8 could also be an internal locking lever so that in this case the security unit 8, 10, 11 takes or can take on the function of a anti-theft device. This is, however, not shown.

The security unit or the locking unit 8, 10, 11 can be controlled by a motor or electric motor 10 to move into the said “locked” and “unlocked” position. Similarly, this is alternatively or additionally provided by the manipulation element 5, as explained in detail below. In case of the locking unit 8, 10, 11 the position “secured” corresponds to the position “locked”, whilst the operating position “unsecured” corresponds to the position “unlocked”. Apart from the described motorized movement, the security unit 8, 10, 11 can also be manually moved into the described positions by the manipulation element 5.

For this purpose, the manipulation element 5 is connected to the output element 11 of the motor 10 according to the invention. Generally, also several output elements can be provided. In this case, the manipulation element 5 can also be connected to these several output elements. In the example embodiment the manipulation element 5 is, however, connected to the (sole) output element 11 of the motor 10. The manipulation element 5 and the respective output element 11 are in this case designed as a single unit. The manipulation element 5 and the output element 11 are a plastic unit 5, 11.

This means that the manipulation element 5 and the output element 11 can be produced simultaneously and in one production step from the same plastic, keeping the costs particularly low. The fact that the unit 5, 11 is made of plastic ensures that any friction between the cylindrical manipulation element 5 and the opening 6 in the door lock housing or motor vehicle door lock housing 3 accommodating the manipulation element 5 and which is also made of plastic is particularly low.

When comparing FIGS. 1 and 2 it is apparent that the output element 11 is a driven pulley 11. The driven pulley 11 or the output element 11 meshes with a worm gear—not expressly shown—connected to an output shaft of the motor 10—also not expressly shown.

It is also apparent from FIGS. 1 and 2 that the cylindrical manipulation element 5 rises up from the output element or advantageously from the driven pulley 11. In contrast to the driven pulley 11, the manipulation element 5 is actually centrally arranged. This allows an operator to move the driven pulley 11 manually with the aid of the manipulation element—not shown—engaging in the slot or actuation slot 7 as if it was moved by the motor 10. This means that the manipulation element 5 or the acting thereon ultimately simulates a motorized movement of the driven element or of the driven pulley 11 and regularly in case that the motor or electric motor 10 has failed or is not able to move the driven pulley 11 into the desired position.

1. Motor vehicle door comprising a motor vehicle door lock (2), also a manipulation element (5) which is accessible from the outer side of the door and which can be impinged on, in addition to a security unit (8, 10, 11) in the motor vehicle door lock (2), and driven by a motor (10) by means of one or more output elements (11) and in which said security unit (8, 10, 11) can be controlled by a motor or manually by means of the manipulation element (5) so that it is placed at least in the “locked” and “unlocked” position, characterized in that the manipulation element (5) is connected to at least one element (11) of the motor (10).

2. Motor vehicle door according to claim 1, characterised in that the manipulation element (5) and the output element (11) form a single unit.

3. Motor vehicle door according to claim 1, characterised in that the manipulation element (5) and the output element (11) form a unit (5, 11) preferably made of plastic.

4. Motor vehicle door according to claim 1, characterised in that the manipulation element (5) is arranged in an opening (6) of a door housing (3).

5. Motor vehicle door according to claim 4, characterised in that the manipulation element (5) is cylindrical and that the opening (6) is a corresponding cylindrical opening (6).

6. Motor vehicle door according to claim 1, characterised in that the manipulation element (5) is designed as a switching nut (5) with an actuating slot (7).

7. Motor vehicle door according to claim 1, characterised in that the output element(11) is a driven pulley (11).

8. Motor vehicle door according to claim 7, characterised in that the driven pulley (11) meshes with a worm gear connected to a driven shaft of the motor (10).

9. Motor vehicle door according to claim 1, characterised in that the manipulation element (5) arises from the output element (11) and preferably perpendicularly.

10. Motor vehicle door according to claim 9, characterised in that in contrast to the output element (11) the manipulation element (5) is centrally arranged.

11. Motor vehicle door according to claim 1, characterized in that the security unit (8, 10, 11) is designed as a locking unit (8, 10 11).

12. Motor vehicle door according to claim 1, characterized in that the output element (11) acts on an external locking element (8) and/or internal locking element.

13. Motor vehicle door according to claim 2, characterised in that the manipulation element (5) and the output element (11) form a unit (5, 11) preferably made of plastic.

14. Motor vehicle door according to claim 13, characterised in that the manipulation element (5) is arranged in an opening (6) of a door housing (3).

15. Motor vehicle door according to claim 14, characterised in that the manipulation element (5) is cylindrical and that the opening (6) is a corresponding cylindrical opening (6).

16. Motor vehicle door according to claim 15, characterised in that the manipulation element (5) is designed as a switching nut (5) with an actuating slot (7).

17. Motor vehicle door according to claim 16, characterised in that the output element(11) is a driven pulley (11).

18. Motor vehicle door according to claim 17, characterised in that the driven pulley (11) meshes with a worm gear connected to a driven shaft of the motor (10).

19. Motor vehicle door according to claim 18, characterised in that the manipulation element (5) arises from the output element (11) and preferably perpendicularly.

20. Motor vehicle door according to claim 19, characterized in that the output element (11) acts on an external locking element (8) and/or internal locking element.
